(19) United States
(12) Patent Application Publication
(10) Pub. No.: US 2004/0236942 A1
(43) Pub. Date: Nov. 25, 2004

(54) System and method for authenticating content user

(75) Inventors: Myung-sun Kim, Euiwang-si (KR); Yong-kuk You, Suwon-si (KR); Yang-lim Choi, Sungnam-si (KR); Yong-jin Jang, Gwacheon-si (KR); Su-hyun Nam, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-city (KR)

(21) Appl. No.: 10/836,405

(22) Filed: May 3, 2004

(30) Foreign Application Priority Data
May 20, 2003 (KR) 10-2003-0032085

(51) Int. Cl. H04L 9/00

(52) U.S. Cl. 713/156; 713/168

(57) ABSTRACT

A system for authenticating a content user, comprising a group common key that authenticates a user, a private key owned by the user, a trusted organization adapted to create and distribute the group common key, and to store personal information on the authenticated user and a temporary registration certificate issued to the authenticated user. A user apparatus converts the temporary registration certificate by means of a predetermined conversion method using the private key, and further provides the converted temporary registration certificate to a content provider prior to executing content provided by the content provider the content provider adapted to check whether the user has been authenticated by the trusted organization, using the group common key prior to providing the content.

### BACKGROUND

This application claims the priority of Korean Patent Application No. 10-2003-0032085 filed on May 20, 2003, in the Korean Intellectual Property Office, the disclosure of which is incorporated herein in its entirety by reference.

1. Field

This disclosure relates to techniques for authenticating a user who uses a variety of contents on a network. Particularly, an authentication system and techniques capable of allowing a legitimate user to securely receive contents without revealing his/her own identity, and preventing an unauthorized user from utilizing the contents are disclosed.

2. Description of the Related Art

Users who are provided with a variety of contents through various types of networks, including the Internet, make use of a variety of encryption methods in order to keep confidentiality of the information distributed on communication networks. However, they are required to provide information on their own identities for legitimate transactions in most cases. But, in many cases keeping confidentiality of the identity of an individual participating in communication is much more important than the protection of data in the communication. Similarly, in case of a home network, it is not unusual for users to intend making legitimate transactions while hiding their own identities.

Techniques for providing content in a conventional way are roughly classified into two types. The first technique does not guarantee confidentiality of the identities of content users, as shown in FIG. 1. In this case, home networks of the users uᵢ and a content provider (CP) constitute a system. The second technique, on the other hand, utilizes an anonymizer in order to guarantee confidentiality of the identities of content users, as shown in FIG. 2. In this case, an anonymizer server is interposed between the CP and the content users uᵢ. The anonymizer prevents extraction of information on the identities of the content users uᵢ from the data associated with the content users uᵢ.

In case of FIG. 1, the identities of the users are not in an encrypted format and thus are revealed as part of any transaction. But, data related to the transactions between the content provider and the content users can be processed so that the data can be kept secret by using an appropriate encryption method. Any conventional encryption technique or a public key-based encryption technique can be used. In the system shown in FIG. 2, since communication and transactions with the outside are made by causing all data on users to pass through the anonymizer, it is possible to guarantee the anonymity of content users in connection with data that passes through the anonymizer.

None of the conventional techniques discussed herein guarantee anonymity of a user's identity. While some techniques attempt to achieve this, they have a limitation in that security is not guaranteed in view of the fact that encryption and data provided to the outside are merely modified. Even in the case of the technique described in relation to FIG. 2, using the anonymizer, if data is obtained prior to passing through the anonymizer, a user's identity can be easily found out in the same manner as FIG. 1.

### SUMMARY

The disclosed teachings are aimed to solving some of the aforementioned problems. There is provided a system for authenticating a content user, comprising a group common key that authenticates a user, a private key owned by the user, a trusted organization adapted to create and distribute the group common key, and to store personal information on the authenticated user and a temporary registration certificate issued to the authenticated user. A user apparatus converts the temporary registration certificate by means of a predetermined conversion method using the private key, and further provides the converted temporary registration certificate to a content provider prior to executing content provided by the content provider. The content provider is adapted to check whether the user has been authenticated by the trusted organization, using the group common key prior to providing the content.

Another aspect of the disclosed teachings is a method of authenticating a content user, comprising creating and distributing a group common key by a trusted organization. Authentication of a user with the trusted organization is performed using the group common key. Personal information on the user authenticated by the trusted organization is stored and a temporary registration certificate is issued to the authenticated user. The temporary registration certificate issued from the trusted organization is converted by means of a predetermined conversion method using a user's own private key. The temporary registration certificate is provided to a content provider. A check is performed to see whether the user who has provided the converted temporary registration certificate has been authenticated. Content is provided depending on the check results.

### BRIEF DESCRIPTION OF THE DRAWINGS

The above and other objects, features and advantages of the disclosed teachings will become apparent from the following description of example implementations given in conjunction with the accompanying drawings, in which:

FIG. 1 illustrates a conventional technique for providing content.

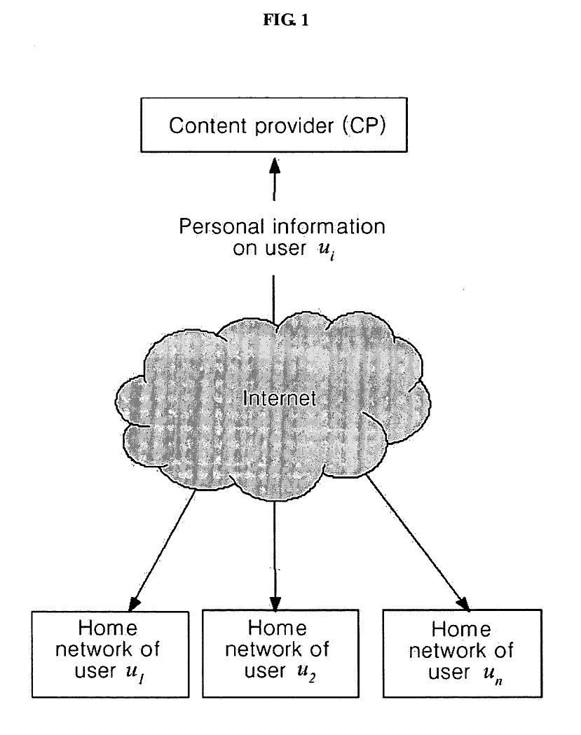

FIG. 2 illustrates another conventional technique for providing content.

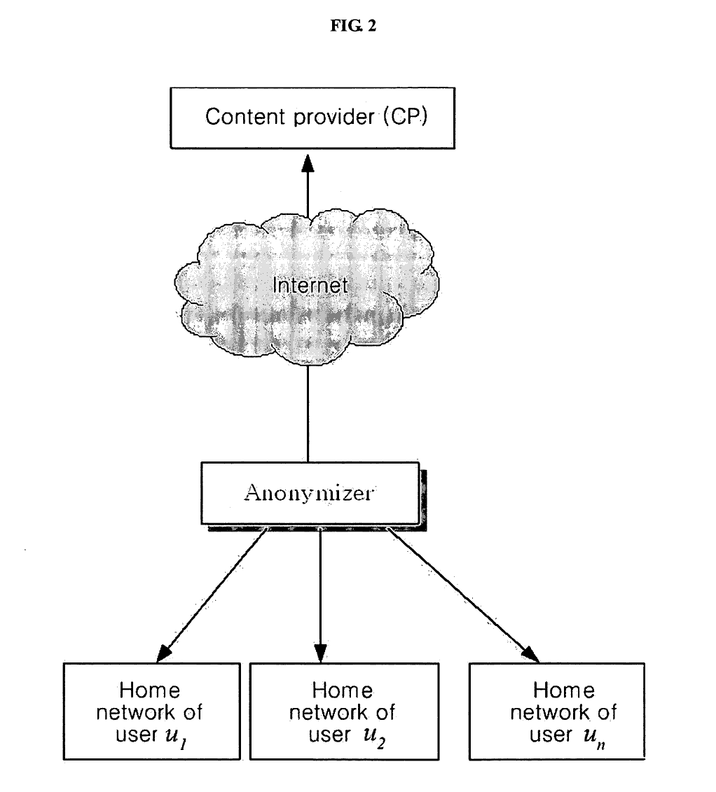

FIG. 3 is a block diagram showing constituent elements of an exemplary authentication system embodying some of the disclosed teachings.

FIG. 4 is a block diagram showing elements and operations of a trusted organization-side apparatus embodying some of the disclosed teachings.

FIG. 5 is a block diagram showing elements and operations of a non-limiting exemplary content user-side apparatus.

FIG. 6 is a block diagram showing elements and operations of a non-limiting exemplary content provider-side apparatus.

FIG. 7 is a flowchart schematically illustrating an example implementation of a technique embodying some aspects of the disclosed teachings.

FIG. 8 is a flowchart illustrating an example of a technique for creating a key by a trusted organization.

FIG. 9 is a flowchart illustrating an example of a technique for performing registration in the trusted organization by a user.

FIG. 10 is a flowchart illustrating an example of a technique for authenticating the user by a content provider.

FIG. 11 is a flowchart illustrating an example of a technique for creating content by the content provider.

FIG. 12 is a flowchart illustrating an example of a technique for confirming a user's identity by the content provider.

### DETAILED DESCRIPTION

Hereinafter, example implementations embodying aspects of the disclosed teachings will be described in detail with reference to the accompanying drawings.

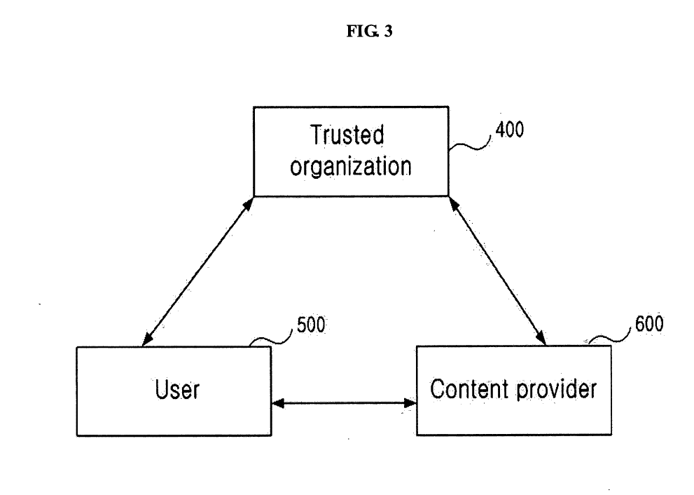

FIG. 3 is a block diagram showing constituent elements of an exemplary authentication system embodying some of the disclosed teachings. As shown in this figure, the example authentication system is implemented with interactions between a trusted organization 400, a content user 500, and a content provider 600. The trusted organization 400 provides the functionality of creating a group common key to be used by a group of content users 500. It also generates, initializes and opens system parameters to the public. These parameters will be used all over the system. It also stores user IDs (personal information) in a database, and searches for a user's ID on the basis of information extracted from content under the agreement with the content provider 600. Knowledge of user information may be necessary for the purpose of tracking an unauthorized user or charging fees. Each user 500 creates a pair of his/her own temporary public key and private key under the agreement with the trusted organization 400. The user then receives a registration certificate that will be used for a subsequent protocol. Finally, the user is authenticated by the content provider 600 based on the registration certificate so that the user can receive and use content. When the user 500 demonstrates that he/she is a legitimate user of a relevant group, the content provider 600 verifies the user's demonstration. Further, the content provider 600 creates content, adds encrypted user information to the created content, and then provides the resultant content to the relevant user 500. Moreover, the content provider 600 can identify a user by obtaining encrypted user information from the trusted organization 400.

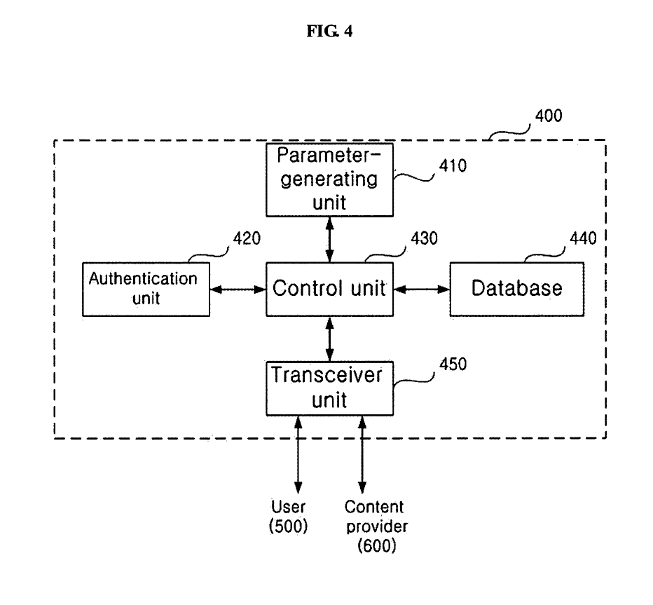

FIG. 4 is a block diagram showing elements and operations of a trusted organization-side apparatus embodying some of the disclosed teachings. The trusted organization-side apparatus 400 comprises a transceiver unit 450, a parameter-generating unit 410, an authentication unit 420, a database 440, and a control unit 430. For example, the transceiver unit 450 receives a value of “t”, a user ID and a value of “α^{x}” sent by the user 500. It then transmits a random number “β” generated by the parameter-generating unit 410 to the user 500. The parameter-generating unit 410 generates a value of “n” that is the basis for computation of a mod value. It also generates exponential values “y” and “z” that are used for exponential computation. In addition, a value of another prime number “v” and arbitrary random numbers α and β are generated. The generated values of “n, v, a, y, z” that are system parameters which will be opened to the public.

The authentication unit 420 extracts user information (user ID) from the relevant content item under the agreement with the content provider 600. It then obtains a user ID from a registrant table stored in the database by using values of “R” and “z”. The database stores various exponents, random numbers and parameters generated from the parameter-generating unit 410. It also stores user IDs received from users. The values of “R” that correspond to temporary registration certificates for users are registered in the database. Further, the control unit 430 controls operations of the transceiver unit 450, the parameter-generating unit 410, the authentication unit 420 and the database 440 and perform various related mathematical operations.

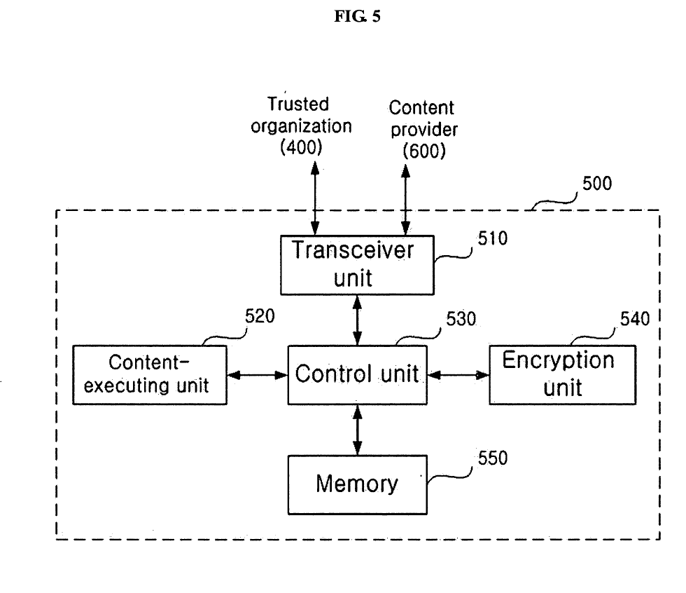

FIG. 5 is a block diagram showing elements and operations of a non-limiting exemplary content user-side apparatus. The content user-side apparatus 500 comprises a transceiver unit 510, a content-executing unit 520, an encryption unit 540, a memory 550, and a control unit 530. The transceiver unit 510 transmits a value of “t” calculated from a random number “α”, a user ID and a value of α^{x} to the trusted organization. It receives a random number “β” from the trusted organization and transmits T₁, T₂, and a value calculated by an ElGamal signature scheme to the content provider 600. It then receives a content item including encrypted user information from the content provider.

The content-executing unit 520 assists the user authentication process of the content provider 600 for a content item received from the content provider 600 and executes the relevant content. The encryption unit 540 generates a random number “r”, and is in charge of calculation of T₁, T₂ and calculations related to the ElGamal signature scheme. The memory 550 functions to temporarily store parameters provided to and received from the trusted organization 400 and the content provider 600. Further, the control unit 530 controls operations of the transceiver unit 510, the content-executing unit 520, the encryption unit 540 and the memory 550, and performs various mathematical related operations.

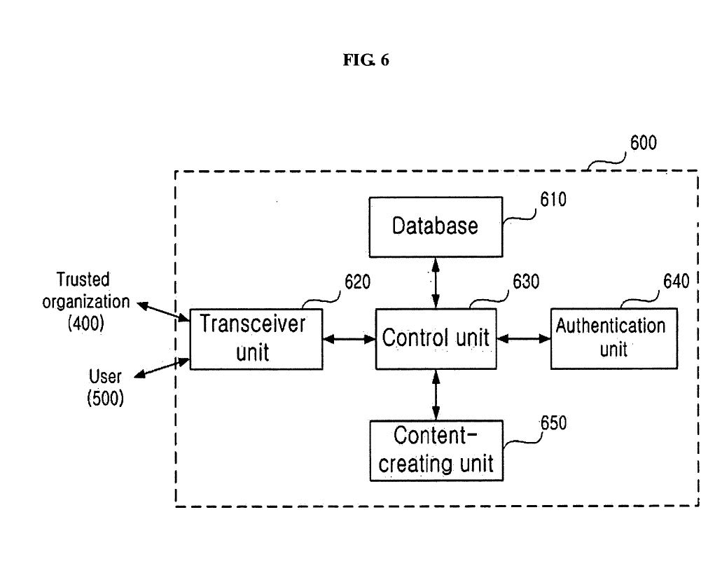

FIG. 6 is a block diagram showing elements and operations of a content provider-side apparatus. The content provider-side apparatus 600 comprises a transceiver unit 620, a content-creating unit 650, an authentication unit 640, a database 610, and a control unit 630. The transceiver unit 620 receives T₁, T₂, and the value calculated by the ElGamal signature scheme from the user 500, and transmit a content item including encrypted user information to the user 500. The content-creating unit 650 creates a variety of original content items and generates content items including new, encrypted user information from the original content items by means of secure two-party computation. The authentication unit 640 performs calculations using the ElGamal signature scheme using a value of W₁. It then checks using such computation whether a user is a legitimate user who has a value of “R” registered in the trusted organization. It also checks whether a user is a legitimate user who knows a random number “r” by again performing the computation using the ElGamal signature scheme if the user again accesses the system.

The database 610 stores parameters provided to and received from the trusted organization 400 and the user 500. It also stores the original content items and the content items with the encrypted user information added to it. Further, the control unit 630 controls operations of the transceiver unit 620, the content-creating unit 650, the authentication unit 640 and the database 610, and performs various related mathematical operations.

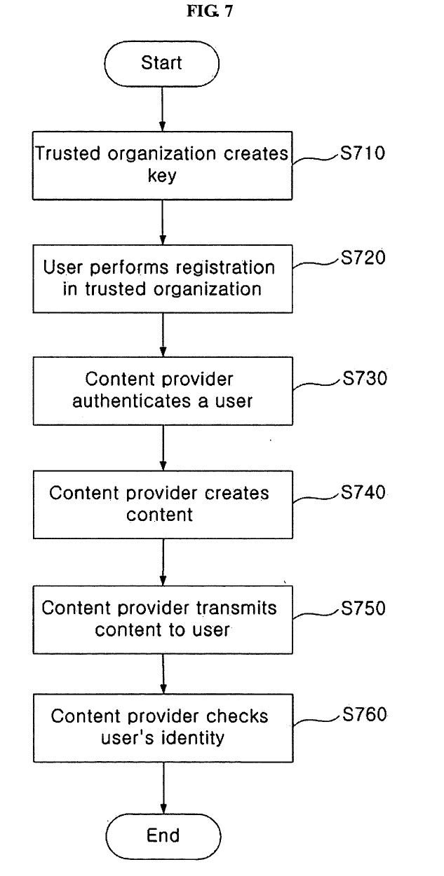

FIG. 7 is a flowchart schematically illustrating an example implementation of a technique embodying some aspects of the disclosed teachings. As shown in FIG. 7, the example implementation roughly comprises six steps and is implemented with interactions of the trusted organization, the content provider, and the content user. First, the trusted organization creates a key (S710). As part of this key creation, the trusted organization creates a group common key to be used by a group of content users. It further creates and opens system parameters, which will be used all over the system, to the public.

Second, the user then registers with the trusted organization (S720). The user creates a pair of user's own temporary public key and private key under the agreement with the trusted organization. The user receives a registration certificate that will be used for subsequent protocols. The registration certificate is similar to a membership card that demonstrates a type of membership.

Third, the content provided authenticates the user (S730). The user shows the content provider that user is a legitimate user of the relevant group. The content provider then verifies the user's demonstration.

Fourth, the content provider creates content and adds encrypted user information to the content (S740). During this step S740, new content to be provided to an authenticated user is generated by performing the secure two-party computation with the use of information on the content's provider and the content user.

Fifth, the content provider transmits the content to the user (S750). In step S750, the content provider provides predetermined content to the relevant user.

Sixth, the content provider checks a user's identity by obtaining the encrypted user information from the trusted organization (S760). Step S760 is performed when a user's identity is required to be checked for the purpose of detecting or tracking an unauthorized user or charging fees.

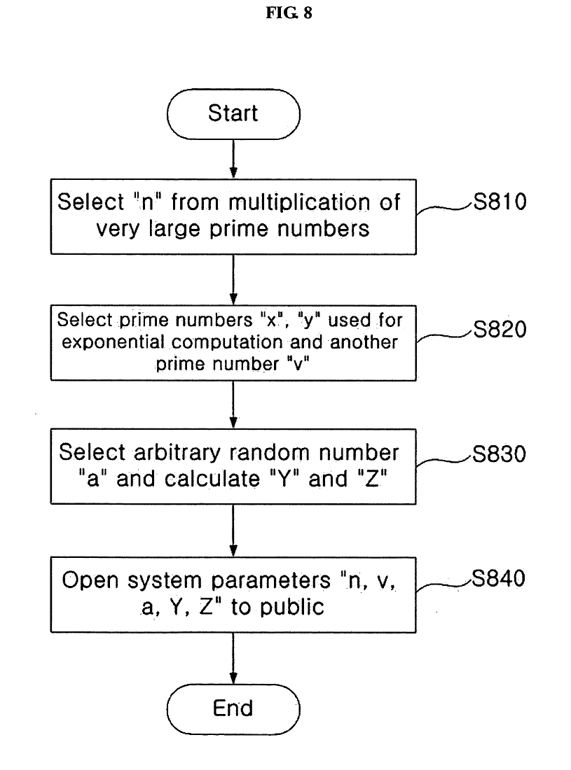

FIG. 8 is a flowchart illustrating an example of a technique for creating a key by a trusted organization. First, n=pq is obtained by selecting very large prime numbers “p” and “q” as in a RSA (Rivest-Shamir-Adleman) scheme (S810). Such a selection makes it difficult to discover the values of “p” and “q” from the value of “n” that is a result of multiplication of the large prime numbers. All mod computation is hereinafter performed on the basis of the value of “n”. Then, exponents “y” and “z” that will be used for exponential computation are selected and stored. Then, another prime number “v” is selected (S820). The exponents “y” and “z” as well as “v” should preferably be prime numbers. Then, an arbitrary random number “a” is selected, and Y=α^{-y} and Z=α^{x} are calculated (S830). Here, the value of “Y=α^{-y}” opens the values of “n, v, a, Y, Z.” These can be defined as system parameters that are part of the parameters finally obtained in the foregoing process, to the content provider and the user (S840).

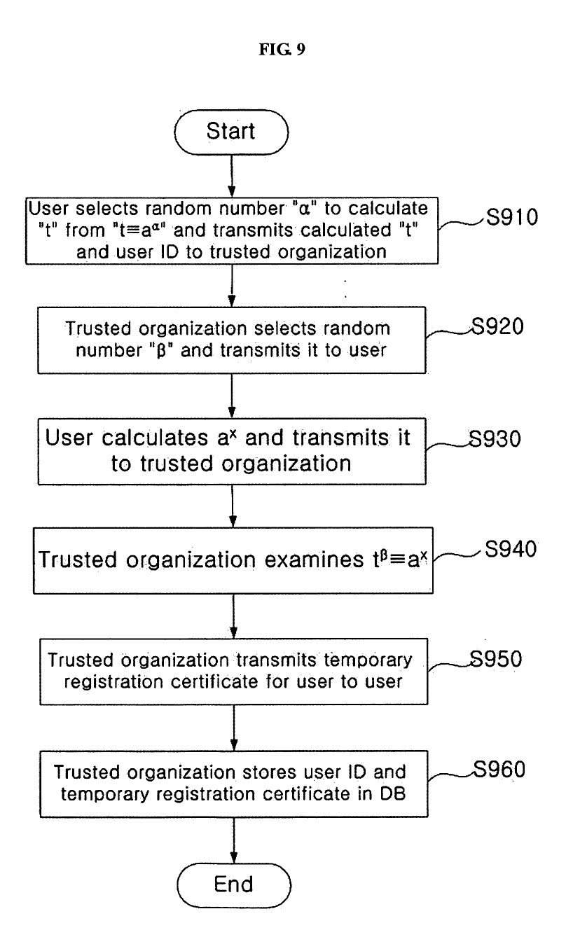

FIG. 9 is a flowchart illustrating an example of a technique for performing registration in the trusted organization by a user. This is a process between the user and the trusted organization. The user selects a random number “α”, computes t≡α^{α}, and then transmits the value of t≡α^{α} together with a user ID to the trusted organization (S910). The formula t≡α^{α} means that a mod value of α^{α} is obtained and the mod value is designated as “t”. Thereafter, the trusted organization selects a random number “β” and transmits it to the user (S920). The user calculates x=α·β using the received “β”, then calculates α^{x}, and transmits it to the trusted organization (S930). The trusted organization examines t^{β}≡α^{x} using the received ax (S940), i.e. whether a mod value of t^{β} is identical with a mod value of α^{x}. If so, the trusted organization recognizes the user as a legitimate user, calculates R=α^{(x+y)·v}^{⁻¹} that is a temporary registration certificate for a user, and transmits it to the user (S950). Last, the trusted organization stores the user ID received from the user and the calculated value of “R” in its own database (S960).

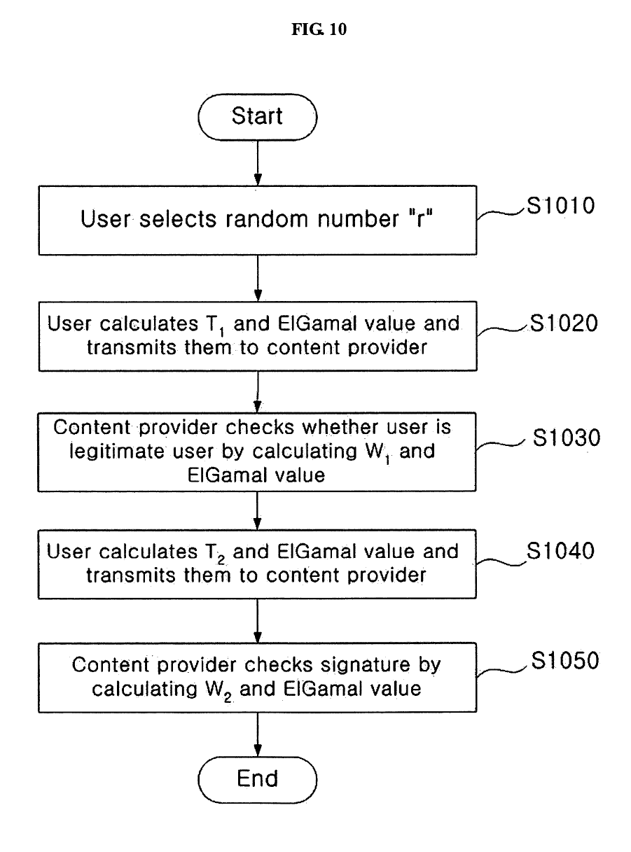

FIG. 10 is a flowchart illustrating an example of a technique for authenticating the user by a content provider. This is a process between the content provider and the user. The user selects a random number “r” (S1010), calculates T₁≡R·α^{r}, calculates ElGamal(“auth”, α^{x+rv}) using the ElGamal signature scheme, and then transmits the two values (S1020). The ElGamal signature scheme or signature checking scheme is already well known to those skilled in the art and more detailed information is available in a paper titled “A public key cryptosystem and a signature scheme based on discrete logarithms” (IEEE Tran. on Information Theory, pp. 469-472, 1985) by T. ElGamal. The term “auth” represents authentication or signature. It is expressed as a function name in the present disclosure.

The content provider first performs ElGamal(“auth”, W₁) by means of the ElGamal signature checking scheme by calculating W₁≡T₁^{v}·Y. Through such a process, the content provider can check whether the user is a legitimate user who has a registered value of “R” (S1030). Thereafter, if the legitimate user calculates T₂≡R⁻¹·Z^{r}·α^{-r} again and transmits ElGamal(“kwg”, α^{zr}) (S1040), the content provider calculates W₂≡T₁·T₂ and checks a signature using ElGamal(“kwg”, W₂, Z) (S1050). Such a process is a process of checking whether the user who has transmitted T₂ is the same as the user who has transmitted T₁, i.e. whether the user who has transmitted T₂ knows the random number “r”. The “kwg” means “knowledge” and represents confirmation of a signature that has already been subjected to the authentication process.

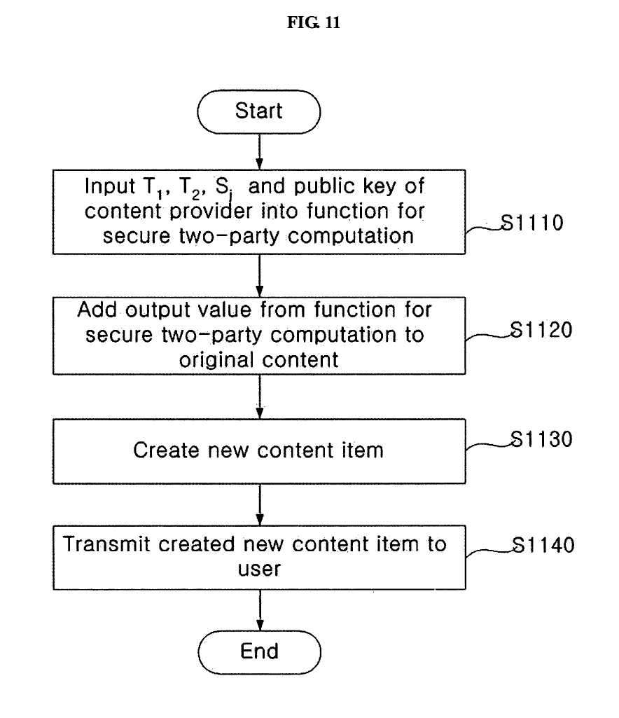

FIG. 11 is a flowchart illustrating an example of a technique for creating content by the content provider. The values of T₁ and T₂ corresponding to the user, Sⱼ representing the value of an arbitrary j-th transaction of the content provider, and a public key of the content provider are input into a function for executing the secure two-party computation (S1110). Here, the transaction value Sⱼ represents a unique transaction number that can be identified with each transaction if the use of content by a user is viewed as one transaction. Further, the public key of the content provider means a provider's unique number for representing a provider that has provided a relevant content. Then, a value output from the function is added to an original content item (S1120) to create a new content item that in turn is transmitted to the user (S1130, S1140).

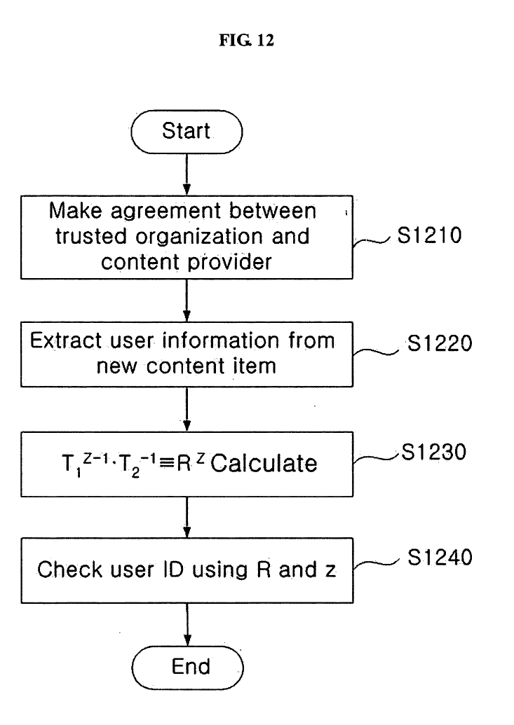

FIG. 12 is a flowchart illustrating an example of a technique for confirming a user's identity by the content provider. This is a process performed between the content provided and the trusted organization. User information is extracted from a relevant content item under the agreement between the content provider and the trusted organization for the purpose of detecting and tracking an unauthorized user or charging fees (S1210, S1220). Then, T₁^{z-1}·T₂⁻¹≡R^{Z} is calculated based on the extracted user information (S1230). The trusted organization obtains a user ID using values of “R” and “z” from the registrant table stored in the database (S1240). If the user is the same, a mod value of T₁^{z-1}·T₂⁻¹ becomes identical with a mod value of R^{Z}. Thus, the trusted organization can recognize the identity of a content user by using the value of “R” previously registered by the user and the value of “z’ selected by the trusted organization itself.

Although the present invention has been described using example implementations thereof, it is not limited thereto. It will be apparent that those skilled in the art can make various changes and modifications without departing from the scope and spirit of the present invention defined by the appended claims.

What is claimed is:

1. A system for authenticating a content user, comprising:
a group common key;
a private key owned by the user;
a trusted organization adapted to create and distribute the group common key, authenticating a user and to store personal information on the authenticated user and a temporary registration certificate issued to the authenticated user;
a user apparatus adapted to convert the temporary registration certificate using a conversion method using the private key, and further adapted to provide the converted temporary registration certificate to a content provider prior to executing content provided by the content provider; and
the content provider adapted to check whether the user has been authenticated by the trusted organization, using the group common key prior to providing the content.

2. The system of claim 1, wherein the trusted organization comprises:
a parameter-generating unit adapted to generate the group common key;
a first authentication unit adapted to authenticate the user;
a database adapted to store personal information on the authenticated user and the temporary registration certificate; and
a first transceiver unit adapted to transmit the group common key and receive an authentication request from the user.

3. The system of claim 2, wherein the content provider comprises:
a second transceiver unit adapted to receive the group common key and the converted temporary registration certificate, and transmit content to the authenticated user;
a second authentication unit adapted to check whether the user who has provided the converted temporary registration certificate has been authenticated by the trusted organization, using the group common key; and
a content-creating unit adapted to provide the content depending on the check results.

4. The system of claim 3, wherein the user apparatus comprises:
an encryption unit adapted to request the trusted organization to authenticate a user and convert the temporary registration certificate using the private key;
a content-executing unit adapted to execute the content; and
a transceiver unit adapted to receive the temporary registration and transmit the converted temporary registration certificate to the content provider.

5. The system of claim 4, wherein the encryption unit converts the temporary registration using a first conversion method and a second conversion method, using the private key.

6. The system of claim 5, wherein the second authentication checks whether the user who has provided the temporary registration certificate converted by the first conversion method has been authenticated by the trusted organization, using the group common key, and
further checks whether the user who has provided the temporary registration certificate converted by the first conversion method knows the private key, using the temporary registration certificates converted by the first and second conversion methods.

7. The system of claim 6, wherein the content-creating unit encrypts content by using the temporary registration certificates converted by the first and second conversion methods and the public key, and provides the encrypted content.

8. The system of claim 7, wherein the content provider provides the temporary registration certificates converted by the first and second conversion methods to the trusted organization, and the trusted organization searches for the personal information on the user registered in the database of the trusted organization by using the temporary registration certificates converted by the first and second conversion methods and the group common key.

9. A method of authenticating a content user, comprising:
creating and distributing a group common key by a trusted organization;
performing authentication of the trusted organization using the group common key;
storing personal information on the user authenticated by the trusted organization and a temporary registration certificate issued to the authenticated user;
converting the temporary registration certificate issued from the trusted organization by means of a predetermined conversion method using a user's own private key;
providing the converted temporary registration certificate to a content provider; and
checking whether the user who has provided the converted temporary registration certificate has been authenticated; and
providing content depending on the check results.

10. The method of claim 9, wherein converting is performed using a sub-process comprising:
(a) converting the temporary registration certificate issued from the trusted organization by means of a first conversion method using the user's private key and providing a first converted temporary registration certificate to the content provider; and
(b) converting the temporary registration certificate issued from the trusted organization by means of a second conversion method using the user's private key and providing a second converted temporary registration certificated t to the content provider.

11. The method of claim 10, wherein checking is performed using a process comprising:
(c) checking whether the user who has provided the first temporary registration certificate has been authenticated by the trusted organization, using the group common key; and
(d) checking whether the user who has provided the first temporary registration certificate knows the private key, using the temporary registration certificates converted by the first and second conversion methods.

12. The method of claim 11, further comprising:
encrypting the content using the first and second temporary registration certificates and a public key of the content provider, and providing the encrypted content to the user.

13. The method of claim 12, further comprising:
providing the first and second temporary registration certificates to the trusted organization, and searching for the personal information on the user registered in the trusted organization using the first and second temporary registration certificates and the group common key.

14. The method of claim 13, wherein the group common key is prime numbers “p” and “q” that are selected according to a RSA (Rivest-Shamir-Adleman) scheme, “n” obtained through multiplication of the prime numbers “p” and “q”, and “Y=α^{-y}” and Z=α^{z}” that are obtained through calculation by applying exponents “y” and “z” to a predetermined random number “a”.

15. The method of claim 14, wherein authentication is performed using a sub-process comprising:
selecting a predetermined random number “α”, calculating t≡α^{α}, and transmitting the calculated value and personal information on the user to the trusted organization;
selecting a predetermined random number “β”, and transmitting it to the user;
calculating “x=α·β” using the received “β”, calculating α^{x}; and
calculating “t^{β}≡α^{x}”using ax, and authenticating the user depending on the calculation results.

16. The method of claim 15, wherein the temporary registration certificate is R=α^{(x+y)·v}^{⁻¹}.

17. The method of claim 16, wherein:
step (a) comprises selecting the user's own private key “r”, calculating the temporary registration certificate T₁^{z-1}≡R·α^{r} converted by the first conversion method, calculating ElGamal(“auth”, α^{x+rv}) using an ElGamal signature scheme, and transmitting the computed value and T₁ to the content provider, and
step (b) comprises calculating the temporary registration certificate T₂≡R⁻¹·Z^{r}·α^{-r} converted by the first conversion method, calculating ElGamal(“kwg”, α^{zr}), and transmitting the calculated value and T² to the content provider.

18. The method of claim 17, wherein:
step (c) comprises checking whether the user is an authenticated user who has a temporary registration certificate “R” registered in the trusted organization by calculating W₁≡T₁^{v}·Y and ElGamal(“auth”, W₁), and
step (d) comprises checking whether the user who has transmitted the temporary registration certificate T₂ converted by the second conversion method knows the private key “r” by calculating W₂≡T₁·T₂ and ElGamal(“kwg”, W₂, Z).

19. The method of claim 18, wherein the temporary registration certificate is converted by calculating T₁^{z-1}·T₂≡R^{Z}.
